(19) United States
(12) Patent Application Publication
(10) Pub. No.: US 2009/0309538 A1
(43) Pub. Date: Dec. 17, 2009

(54) ENERGY STORAGE AND MANAGEMENT CIRCUIT

(76) Inventor: Jian Xu, Windsor (CA)

Correspondence Address: Carlson, Gaskey & Olds/Masco Corporation, 400 West Maple Road, Suite 350, Birmingham, MI, 48009, US

(21) Appl. No.: 12/420,309

(22) Filed: Apr. 8, 2009

Related U.S. Application Data
(60) Provisional application No. 61/061,673, filed on Jun. 16, 2008.

(51) Int. Cl. H01M 10/46; H02J 7/00

(52) U.S. Cl. 320/101; 320/137; 320/166

(57) ABSTRACT

An energy storage and management circuit includes an energy harvester, a switch coupled to the energy harvester, a first energy storage device coupled to the switch, and a second energy storage device coupled to the switch. The first energy storage device is operable to store energy from the energy harvester. The second energy storage device is operable to charge from a leakage current of the switch.

The application claims priority to U.S. Provisional Application No. 61/061,673 which was filed on Jun. 16, 2008.

### BACKGROUND OF THE INVENTION

This application relates to energy storage, and more specifically to an energy storage and management circuit.

A switch is a device used to control a flow of electric current in a circuit. A switch typically has a first terminal A, and a second terminal B. If a switch is turned ON, the switch allows current to flow between terminals A and B. If a voltage potential is higher at A than at B, current may flow from A to B. If a voltage potential is higher at B than at A, current may flow from B to A. However, even if a switch is turned OFF, a small leakage current may still flow between the terminals A and B.

Some devices that may be used as switches include diodes and MOSFETs. A diode is a device that permits current to flow in at least a first direction. Some diodes, such as Zener diodes, may also permit current to flow in a second direction that is opposite the first direction. A Zener diode has a breakdown voltage that corresponds to a voltage at which the Zener diode will permit current to flow in the second direction. Although an ideal Zener diode has a specified breakdown voltage and no leakage current, in actuality Zener diodes permit a small amount of leakage current to flow in the second direction even if the specified breakdown voltage is not applied to the Zener diode.

### SUMMARY OF THE INVENTION

An energy storage and management circuit includes an energy harvester, a switch coupled to the energy harvester, a first energy storage device coupled to the switch, and a second energy storage device coupled to the switch. The first energy storage device is operable to store energy from the energy harvester. The second energy storage device is operable to charge from a leakage current of the switch.

A method of storing energy includes harvesting energy from an energy harvester, charging a first energy storage device with the energy from the energy harvester, and charging a second energy storage device using a leakage current of a switch. The switch is coupled to the first energy storage device and is coupled to the energy harvester

These and other features of the present invention can be best understood from the following specification and drawings, the following of which is a brief description.

### BRIEF DESCRIPTION OF THE DRAWINGS

FIG. 1 schematically illustrates an energy storage and management circuit.

### DETAILED DESCRIPTION OF THE PREFERRED EMBODIMENT

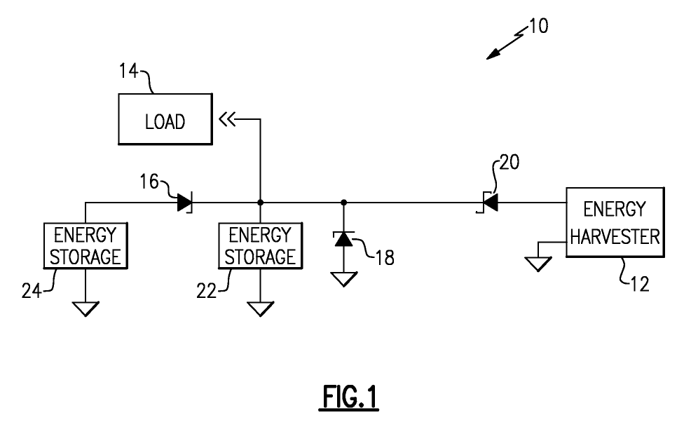

FIG. 1 schematically illustrates an energy storage and management circuit 10. The circuit 10 includes an energy harvester 12 operable to harvest energy, a load 14, a first energy storage device 22, a second energy storage device 24, a first switch 16, a second switch 18, and a third switch 20. In one example the energy harvester 12 corresponds to a solar energy harvester, such as a solar cell or photovoltaic. In another example the energy harvester 12 corresponds to a thermal energy harvester, a mechanical energy harvester, or any other type of harvester operable to harvest energy from either an ambient environment or from another energy source. One example mechanical energy harvester can be found in the EnOcean PTM 200 Pushbutton Transmitter Module. One example solar energy harvester is available from EnOcean under product number STM 110. One example thermal energy harvester is available from EnOcean under product number ECT 100. The energy harvester 12 may also correspond to a converter, such as an alternating current (AC) to direct current (DC) converter.

Each energy storage device 22, 24 may correspond to a capacitor, a battery (such as a lithium-ion battery), a power supply, or some other energy storage media. In one example the energy storage devices 22, 24 correspond to a capacitor-based power supply for an electronic circuit, such as a circuit for a self-energizing switch operable to transmit wireless signals (e.g. the EnOcean PTM 200).

In the example of FIG. 1, the switches 16-20 correspond to diodes. However, it is understood that other types of switches could be used, such as n-channel MOSFETs, p-channel MOSFETs, or transistors. As shown in FIG. 1, the first switch 16 and the second switch 18 are Zener diodes and third switch 20 is a Schottky diode. However, it is understood that other types of diodes could be used.

The first switch 16 is operable to control a flow of current between the first energy storage device 22 and the second energy storage device 24. The first energy storage device 22 is operable to quickly charge from the energy harvester 12 and provide a current to the load 14, and thus may be described as having a “quick startup time.” The second energy storage device 24 is operable to charge when the first switch 16 is OFF and a leakage current flows through the first switch 16 to the second energy storage device 24 from the either first energy storage device 22 or the energy harvester 12. The first switch 16 may be selected so that its leakage current is much lower than a current supplied by the energy harvester 12.

The second energy storage device 24 is also operable to charge when the first switch 16 is partially ON or completely ON, and permits a charging current to flow to the energy storage device 24. For example, if the first switch 16 is a Zener diode, and a voltage of the first energy storage device 22 exceeds a Zener diode breakdown voltage of the first switch 16, the first switch 16 could permit charging current to flow from the first energy storage device 22 to the second energy storage device 24 to charge the second energy storage device 24. As another example, if the first switch 16 was a MOSFET, the MOSFET could be partially ON in a linear region, and could be completely ON in a saturation region.

In one example the second energy storage device 24 has an energy storage capacity that is greater than an energy storage capacity of the first energy storage device 22. In this example, the second energy storage device 24 may be selected to have a sufficient energy storage capacity to maintain the circuit 10 in a normal operation mode longer than would be possible with just the first energy storage device 22.

The second switch 18 is operable to provide an over-voltage protection when the energy harvester 12 harvests an abundant amount of energy. For example, if the energy harvester 12 is a solar energy harvester, and is in contact with strong light such that an amount of energy harvested by the energy harvester 12 exceeds a breakdown voltage of the second switch 18, the second switch 18 may provide a connection, such as a ground connection, to dissipate the excessive amount of harvested energy and protect the load 14 from damage.

In one example a breakdown voltage of the second switch 18 is greater than a breakdown voltage of the first switch 16 such that the second energy storage device 24 will have an opportunity to charge through the first switch 16 before the second switch 18 provides an over-voltage protection function by dissipating an excessive amount of harvested energy.

The third switch 20 permits a flow of current from the energy harvester 12 to the first energy storage device and prevents a flow of current from the first energy storage device 22 back to the energy harvester 12. Using a Schottky diode for the third switch 20 may provide a low voltage drop across the third switch 20 so that a minimal amount of energy is dissipated across the third switch 20.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An energy storage and management circuit comprising:
an energy harvester;
a first switch coupled to the energy harvester;
a first energy storage device coupled to the switch and operable to store energy from the energy harvester; and
a second energy storage device coupled to the first switch and operable to charge from a leakage current of the first switch.

2. The circuit of claim 1, wherein the second energy storage device is operable to charge from the leakage current of the first switch when the first switch is in an OFF state.

3. The circuit of claim 1, wherein the second energy storage device is also operable to charge from a charging current from the first energy storage device or from the energy harvester when the first switch is in an ON state.

4. The circuit of claim 3, wherein the ON state corresponds to the first switch being either completely ON or partially ON.

5. The circuit of claim 1, wherein the first switch comprises a Zener diode, and wherein the Zener diode permits a charging current to flow from the first energy storage device to the second energy storage device in response to a voltage of the first energy storage device exceeding a breakdown voltage of the Zener diode.

6. The circuit of claim 1, wherein the first energy storage device has a first energy storage capacity, and the second energy storage device has a second energy storage capacity that is greater than the first energy storage capacity.

7. The circuit of claim 1, wherein each of the first energy storage device and the second energy storage device are either batteries or capacitors.

8. The circuit of claim 6, wherein one of the first energy storage device and the second energy storage device is a battery, and another of the first energy storage device and the second energy storage device is a capacitor.

9. The circuit of claim 1, wherein the first energy storage device and the second energy storage device correspond to a power supply for a self-energizing switch operable to transmit a wireless signal.

10. The circuit of claim 1, wherein the energy harvester is operable to harvest at least one of solar energy, thermal energy, or mechanical energy.

11. The circuit of claim 1, wherein the energy harvester is an alternating current to direct current converter.

12. The circuit of claim 1, further comprising a second switch coupled to the first switch and operable to provide an over-voltage protection.

13. The circuit of claim 12, wherein the second switch is a Zener diode.

14. The circuit of claim 1, further comprising a third switch coupled to the energy harvester and operable to prevent a flow of current from the first energy storage device to the energy harvester.

15. The circuit of claim 14, wherein the third switch is a Schottky diode.

16. A method of storing energy, comprising:
harvesting energy from an energy harvester;
charging a first energy storage device with the energy from the energy harvester; and
charging a second energy storage device using a leakage current of a first switch, wherein the second energy storage device is coupled to the first energy storage device and is coupled to the energy harvester.

17. The method as recited in claim 16, wherein the second energy storage device charges using the leakage current of the first switch when the first switch is in an OFF state.

18. The method as recited in claim 17, further comprising:
charging the second energy storage device from a charging current of the energy harvester when the first switch is in an ON state.

19. The method as recited in claim 18, wherein the first switch enters an ON state in response to a voltage of the first energy storage device exceeding a breakdown voltage of the first switch.

20. The method as recited in claim 17, further comprising:
dissipating a portion of the energy from the energy harvester through a second switch coupled to a ground connection in response to the energy from the energy harvester exceeding a breakdown voltage of the second switch.
